(19) United States
(12) Patent Application Publication
(10) Pub. No.: US 2025/0264074 A1
(43) Pub. Date: Aug. 21, 2025

(54) DETONATION PRE-COMBUSTORS

(71) Applicant: VENUS AEROSPACE CORP, Houston, TX (US)

(72) Inventors: Andrew Thomas Duggleby, Friendswood, TX (US); William Thomas Ross, League City, TX (US)

(21) Appl. No.: 18/444,483

(22) Filed: Feb. 16, 2024

(51) Int. Cl. F02K 9/48; F02K 9/42; F02K 9/64

(52) U.S. Cl. CPC F02K 9/48; F02K 9/425; F02K 9/64

(57) ABSTRACT

A rocket system includes a main rocket engine; a preburner engine; a propellant system configured to introduce a fuel and an oxidizer into the main rocket engine and into the preburner engine; and a fuel pump and an oxidizer pump driven by a turbine configured to pump the fuel and the oxidizer to the main rocket engine. The preburner comprises a Rotating Detonation Engine (RDE) configured to drive the turbine. Liquid oxidizer is injected through side walls of a combustion section of the RDE and/or mixed with combustion products of the RDE to protect the turbine from excess heat from the RDE exhaust.

### FIELD OF THE DISCLOSURE

The present disclosure relates to rocket engines. More particularly the disclosure relates to methods and systems for providing propellants, i.e., oxidizer and fuel to rocket engines. The disclosure has particular utility with respect to pumping liquid oxidizer and liquid fuel to rocket engines and will be described in connection with such utility.

### BACKGROUND AND SUMMARY

This section provides background information related to the present disclosure which is not necessarily prior art. This section provides a general summary of the disclosure and is not a comprehensive disclosure of its full scope or all its features.

Rocket engines are reaction engines, producing thrust by ejecting mass rearward in accordance with Newton's Third Law. Most rocket engines employ combustion of reactive chemicals to supply the necessary energy. There are two different types of combustion rocket engines. Deflagration rocket engines employ a type of combustion that propagates through heat transfer, at subsonic speed, through a medium. Detonation rocket engines employ a type of combustion that propagates through shock waves at supersonic speed through a medium.

More particularly, Rotating Detonation Engines (RDEs) are engines using a form of pressure gain combustion, based on a detonation wave traveling around an annular reaction channel or annulus. The use of a supersonic flame front allows higher chamber pressures, resulting in higher thrust, than a deflagrative rocket engine. Detonative combustion also results in a smaller reaction zone, permitting a more compact design and a reduction in RDE size and mass, making RDEs more efficient relative to conventional rocket engines employing deflagrative combustion.

In operation of an RDE, a fuel and oxidizer are injected into a reaction channel, normally through small holes or slits, and detonation is initiated in the fuel/oxidizer mixture by an ignition source. After the engine is started, detonation is self-sustaining to maintain operation of the RDE—that is, once the fuel/oxidizer mixture ignites, the energy released sustains the detonations or detonation wavefront in subsequent order. The products of detonation combustion expand out of the reaction channel and are further pushed out of the reaction channel by incoming fuel and oxidizer, resulting in a propelling force capable of driving an aircraft or rocket at supersonic or hypersonic speed.

Rocket engines require a way to provide propellants, i.e., oxidizer and fuel to the engine. For large, high performance rocket engines such as the Aerojet Rocketdyne RS Space Shuttle Main Engine, high-pressure, high-volume pumps are employed to ensure sufficient propellant flow. The oxidizer pumps and the fuel pumps are driven by a hot-gas turbine which in turn is powered by a conventional deflagration combustion engine (often referred to as a “preburner” or “gas generator”). In the case of the Aerojet Rocketdyne RS Space Shuttle Maine Engine, the main oxidizer pump reportedly operates at approximately 28,120 rpm providing a power output of 23,260 hp, while the main fuel pump reportedly operates at approximately 35,360 rpm providing a power output of 71,140 hp. Hot-gas turbines and pumps of such capacity are heavy and bulky. Also, deflagrative combustion involves a pressure loss across the gas generator, which reduces efficiency when combustion products are injected into the rocket main combustion chamber.

In accordance with the present disclosure, we replace a conventional deflagrative combustion engine and turbine in a rocket system with a preburner RDE to drive a turbine to power the oxidizer and fuel pumps for the main rocket engine. Since RDEs are more efficient than conventional deflagration combustion engines, the RDE and turbine can be significantly smaller in volume and mass than conventional deflagration combustion engines and turbines of comparable power output. Also, the detonative combustion of an RDE produces a pressure gain across the pre-combustor in contrast to a pressure loss associated with deflagrative combustion. As a result, overall system efficiency is improved when preburner exhaust is introduced into the main combustion chamber of the main rocket engine downstream after the turbine. In order to protect the turbine from the high temperature exhaust from the RDE preburner, which might otherwise melt or damage turbine components, in accordance with the present disclosure, we reduce the RDE preburner exhaust temperature by addition of liquid oxidizer. The oxidizer can be introduced by injecting the liquid oxidizer through walls of the RDE reaction chamber, i.e., to film-cool the reaction chamber walls, and/or by mixing the liquid oxidizer directly with the post-detonation gases, or both. After exiting the turbine, the oxidizer and preburner reaction products are then introduced to the main rocket engine combustion chamber (along with fuel and optionally additional oxidizer) to power the main rocket engine.

Prior to the present disclosure, using an RDE to drive a turbine would not be feasible with conventional configurations, since RDE exhaust temperatures are too high and could melt or damage turbine components such as turbine blades. Additionally, the detonation waves may damage turbine components. However, in accordance with the present disclosure, we employ liquid oxidizer to absorb heat and cool the RDE combustion chamber and/or RDE combustion products. As a result, the present disclosure enables us to employ an RDE preburner rocket engine to drive a turbine for powering oxidizer and fuel pumps for a main rocket engine.

According to one embodiment, the oxidizer introduced into the preburner has been used for regenerative cooling of the main combustion chamber and main engine before being pumped to the preburner.

In another embodiment, the oxidizer introduced to the preburner is pumped directly from the oxidizer tanks, without being used for regenerative cooling of the main combustion chamber and main engine.

In another embodiment, liquid oxidizer is used for film-cooling the preburner RDE reaction chamber walls.

In yet another embodiment, the liquid oxidizer is used to cool reaction products of the preburner RDE through introduction of a large quantity of liquid oxidizer to quench the mixture upstream of the turbine.

In yet another embodiment, liquid oxidizer is injected through walls of the turbine to film-cool the turbine walls.

The RDE combustion products are delivered to power a turbine which in turn is used to power the rocket engine fuel pump and oxidizer pump. After passing through the turbine, the RDE combustion products and the injected oxidizer are then flowed to the main rocket engine combustion chamber.

More particularly, according to aspect A there is provided a rocket system comprising: a main rocket engine; a preburner engine; a propellant system configured to introduce a fuel and an oxidizer into the main rocket engine and into the preburner engine; and a fuel pump and an oxidizer pump driven by a turbine configured to pump the fuel and the oxidizer to the main rocket engine, wherein the preburner comprises a Rotating Detonation Engine (RDE) configured to drive the turbine, wherein liquid oxidizer is injected through side walls of a combustion section of the RDE and/or mixed with combustion products of the RDE to protect the turbine from excess heat from the RDE exhaust.

In one embodiment the main rocket comprises a deflagration rocket engine.

In another embodiment the main rocket engine comprises a RDE.

In a further embodiment liquid oxidizer is also injected through walls of the turbine to film-cool the walls of the turbine.

In yet another embodiment the liquid oxidizer comprises an oxidizer liquid at ambient temperature.

In a further embodiment the oxidizer comprises H₂O₂ or N₂O₄.

In another embodiment the liquid oxidizer comprises liquified oxygen (LOX).

In yet another embodiment the rocket fuel is selected from the group consisting of hydrogen, ammonia, monomethylhydrazine, or unsymmetrical dimethylhydrazine.

In still yet another embodiment the fuel comprises a combustible liquid hydrocarbon.

In a further embodiment the combustible liquid hydrocarbon is selected from the group consisting of methane, propane, and kerosene.

According to aspect B there is provided a method for operating a rocket system comprising a main rocket engine; a preburner engine; a propellant system configured to introduce a fuel and a liquid oxidizer into the main rocket engine and into the preburner engine; a fuel pump and an oxidizer pump driven by a turbine configured to pump the fuel and the oxidizer to the main rocket engine, and a turbine configured to be driven by the preburner engine, said method comprising providing as the preburner engine a Rotating Detonation Engine (RDE), and injecting liquid oxidizer through side walls of a combustion section of the RDE and/or mixed with combustion products of the RDE to protect the turbine from excess heat from the RDE exhaust.

In one embodiment of the method the main rocket comprises a deflagration rocket engine.

In another embodiment of the method the main rocket engine comprises a RDE.

In a further embodiment of the method liquid oxidizer is also injected through walls of the turbine to film-cool walls of the turbine.

In yet another embodiment of the method the liquid oxidizer comprises an oxidizer liquid at ambient temperature.

In another embodiment of the method the oxidizer comprises H₂O₂ or N₂O₄.

In a further embodiment of the method the liquid oxidizer comprises liquified oxygen (LOX).

In yet another embodiment of the method the rocket fuel is selected from the group consisting of hydrogen, ammonia, monomethylhydrazine, or unsymmetrical dimethylhydrazine.

In another embodiment of the method the rocket fuel comprises a combustible liquid hydrocarbon.

In still another embodiment of the method the combustible liquid hydrocarbon is selected from the group consisting of methane, propane, and kerosene.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Further features and advantages of the instant disclosure will be seen from the following detailed description taken in connection with the accompanying drawings, wherein like numerals depict like parts. The drawings described herein are for illustrative purposes only of selected embodiments and not all possible implementations and are not intended to limit the scope of the present disclosure.

FIG. 1 is a cross-sectional view of a rocket engine employing an RDE preburner and turbine in accordance with the present disclosure; and

FIG. 2 is a block diagram of operation of a rocket engine including an RDE preburner and turbine in accordance with the present disclosure.

### DETAILED DESCRIPTION OF THE DISCLOSURE

Example embodiments will now be described more fully with reference to the accompanying drawings. Example embodiments are provided so that this disclosure will be thorough and will fully convey the scope to those who are skilled in the art. Numerous specific details are set forth such as examples of specific components, devices, and methods to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, components and/or groups, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer, or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

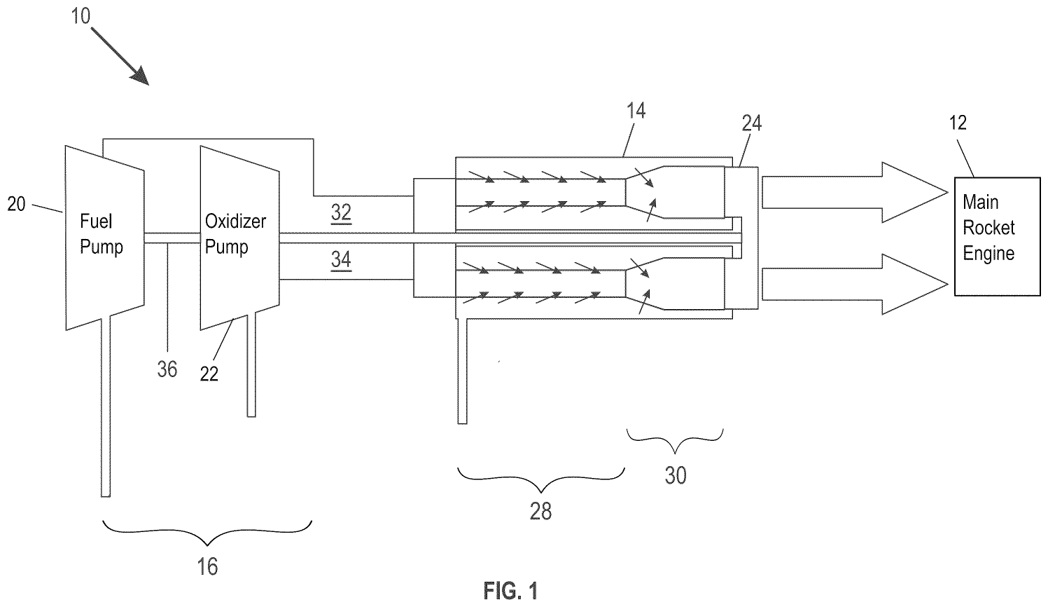

Referring to FIG. 1, a rocket system 10 in accordance with the present disclosure comprises a main rocket engine 12 and a preburner RDE 14.

Rocket system 10 includes a propellant introduction system 16 configured to introduce fuel and oxidizer into the main rocket engine 12 and into the preburner RDE 14. Propellant introduction system 16 includes a fuel pump 20 and an oxidizer pump 22. Fuel pump 20 and oxidizer pump 22 are driven by a turbine 24 which is downstream of preburner RDE 14, which in turn is driven by combustion products exiting from preburner RDE 14. The oxidizer may comprise a cryogenic oxidizer, e.g., liquid oxygen (LOX) or an ambient temperature liquid oxidizer such as liquid H₂O₂ or liquid N₂O₄. Fuel and oxidizer are supplied to pump 20 and pump 22 via conduits (not shown) from on board fuel and oxidizer stores (not shown). The fuel may be hydrogen, ammonia, monomethylhydrazine or unsymmetrical dimethylhydrazine or a combustible liquid hydrocarbon conventionally used as rocket fuel, such as methane, propane, or kerosene.

Preburner RDE 14 includes an RDE combustion section 28 in which fuel and liquid oxidizer are introduced and reacted or combusted, and an outlet section 30, wherein expanding combustion products are routed to drive a turbine 24. Fuel and liquid oxidizer feed for the preburner RDE 14 are supplied by tapping from the fuel pump 20 and liquid oxidizer pump 22 via tap lines 32 and 34, respectively.

In order to protect the turbine 24 from the high temperature exhaust of the preburner RDE 14, liquid oxidizer is injected through side walls of the RDE combustion section 28 to provide film-cooling of the walls of the RDE combustion section 28. Liquid oxidizer also may be mixed with the preburner engine RDE combustion products in outlet section 30 to absorb heat from the RDE combustion products and reduce the mixture temperature at the turbine 24 inlet. Film-cooling also may be provided along part of or along the entirety of the outlet section 30 in addition to mixing quantities of liquid oxidizer into the combustion products in outlet section 30.

The liquid oxidizer injected into the preburner RDE 14 absorbs heat from the RDE combustion section 28 where it may be used for regenerative cooling. In an alternative embodiment, the liquid oxidizer also may be used for film-cooling walls of the turbine 24 itself.

Power from spinning turbine 24 is transferred to fuel pump 20 and liquid oxidizer pump 22 via a drive shaft 36.

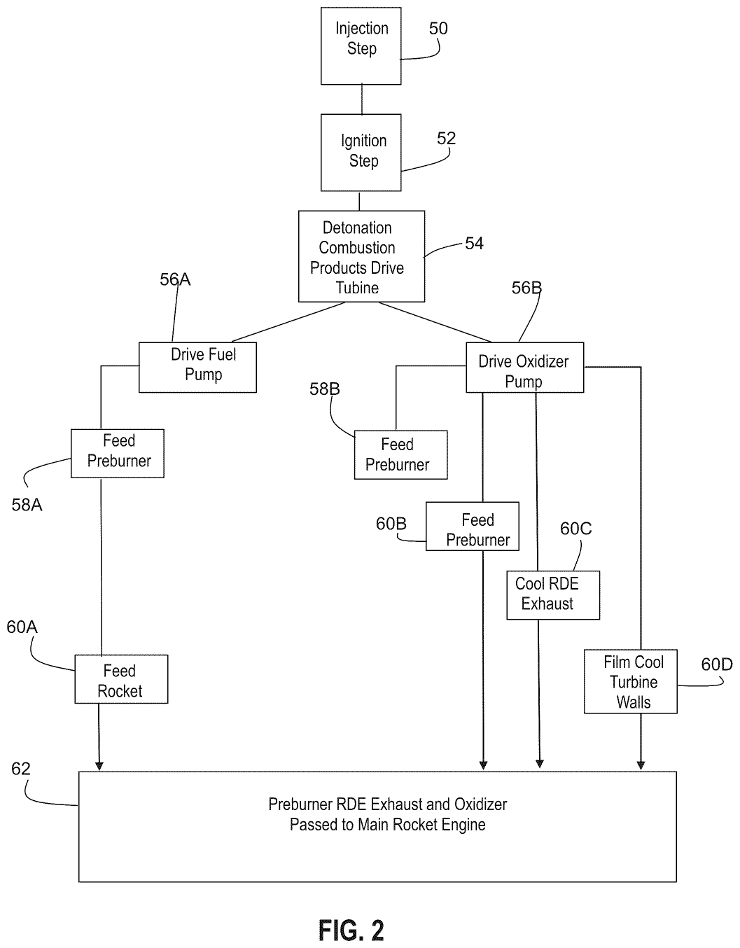

Referring to FIG. 2, operation of a rocket system 10 proceeds as follows: A fuel and liquid oxidizer, which are stored in pressurized tanks, are injected into reaction chamber 22 of preburner RDE 14 in injection step 50. Detonation is initiated in the fuel/oxygen mixture in an ignition step 52. After detonation commences, detonation is self-sustaining to maintain operation of the RDE. The products of detonation combustion expand out of combustion chamber 28 into outlet section 30 where they are passed to drive or spin turbine 24 in step 54. The spinning turbine in turn drives fuel pump 20 (step 56A) and oxidizer pump 22 (step 56B). Fuel and liquid oxidizer are tapped from fuel pump output and oxidizer pump output, respectively, and fed to the preburner RDE to maintain operation of the RDE in step 58A, 58B. The main output of fuel pump 20 is passed to the main rocket 12 in step 60A, while a portion of the liquid oxidizer output from oxidizer pump 22 is passed to preburner RDE 14 in step 60B where it is injected through the walls of the RDE combustion section 28 to film-cool the walls of the combustion section 28. Liquid oxidizer also may be mixed with the reaction products of the RDE in outlet section 30 in step 60C to reduce the temperature of the RDE exhaust in order to protect the components of the turbine 24. Liquid oxidizer also may be injected through walls of the turbine to film-cool the turbine walls in step 60D. After passing through the turbine, the preburner RDE exhaust and the oxidizer are then passed to the main rocket 12 in step 62.

The use of oxidizer film-cooling of the preburner RDE combustion section walls and post-combustion introduction of liquid oxidizer into the exhaust of the RDE reduces the RDE exhaust temperature, thus permitting the use of a preburner RDE to drive a turbine for powering the fuel and liquid oxidizer pumps. A feature and advantage of employing an RDE as a preburner rocket engine to drive a turbine in accordance with the present disclosure is that the RDE and turbine may be made smaller in size and mass than an equivalent performance conventional deflagration combustor and turbine, and also achieve higher turbine inlet pressure than a conventional deflagration rocket engine and turbine. Thus, cycle and mass efficiency of the rocket engine is increased.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Various changes and advantages may be made in the above disclosure without departing from the spirit and scope thereof.

What is claimed:

1. A rocket system comprising:
a main rocket engine;
a preburner engine;
a propellant system configured to introduce a fuel and an oxidizer into the main rocket engine and into the preburner engine; and
a fuel pump and an oxidizer pump driven by a turbine configured to pump the fuel and the oxidizer to the main rocket engine, wherein the preburner engine comprises a Rotating Detonation Engine (RDE) configured to drive the turbine, wherein liquid oxidizer is injected through side walls of a combustion section of the RDE and liquid oxidizer also is mixed with combustion products of the RDE to bring down a temperature of the RDE combustion products. such that active cooling of the turbine is not required to protect the turbine from excess heat from the RDE exhaust.

2. The rocket engine of claim 1, wherein the main rocket engine comprises a deflagration rocket engine.

3. The rocket engine of claim 1, wherein the main rocket engine comprises a RDE.

4. The rocket engine of claim 1, wherein liquid oxidizer is also injected through walls of the turbine to film-cool the walls of the turbine.

5. (canceled)

6. The rocket engine of claim 1, wherein the liquid oxidizer comprises H₂O₂ or N₂O₄.

7. The rocket engine of claim 1, wherein the liquid oxidizer comprises liquified oxygen (LOX).

8. The rocket engine of claim 1, wherein the fuel is selected from the group consisting of hydrogen, ammonia, monomethylhydrazine, and unsymmetrical dimethylhydrazine.

9. The rocket engine of claim 1, wherein the fuel comprises a combustible liquid hydrocarbon.

10. The rocket engine of claim 9, wherein the combustible liquid hydrocarbon is selected from the group consisting of methane, propane, and kerosene.

11. A method for operating a rocket system comprising a main rocket engine; a preburner engine; a propellant system configured to introduce a fuel and a liquid oxidizer into the main rocket engine and into the preburner engine; a fuel pump and an oxidizer pump driven by a turbine configured to pump the fuel and the oxidizer to the main rocket engine; and the turbine configured to be driven by the preburner engine, said method comprising:
providing as the preburner engine a Rotating Detonation Engine (RDE) and injecting liquid oxidizer through side walls of a combustion section of the RDE and liquid oxidizer also is mixed with combustion products of the RDE to bring down a temperature of the RDE combustion products, such that active cooling of the turbine is not required to protect the turbine from excess heat from the RDE exhaust.

12. The method of claim 11, wherein the main rocket engine comprises a deflagration rocket engine.

13. The method of claim 11, wherein the main rocket engine comprises a RDE.

14. The method of claim 11, wherein liquid oxidizer is also injected through walls of the turbine to film-cool walls of the turbine.

15. (canceled)

16. The method of claim 11, wherein the liquid oxidizer comprises H₂O₂ or N₂O₄.

17. The method of claim 11, wherein the liquid oxidizer comprises liquified oxygen (LOX).

18. The method of claim 11, wherein the fuel is selected from the group consisting of hydrogen, ammonia, monomethylhydrazine, and unsymmetrical dimethylhydrazine.

19. The method of claim 11, wherein the fuel comprises a combustible liquid hydrocarbon.

20. The method of claim 19, wherein the combustible liquid hydrocarbon is selected from the group consisting of methane, propane, and kerosene.

21. The rocket engine of claim 1, wherein liquid oxidizer is also mixed with combustion products of the preburner engine to reduce the temperature at the turbine inlet.

22. The rocket engine of claim 11, wherein liquid oxidizer is also mixed with combustion products of the preburner engine to reduce the temperature at the turbine inlet.
